(19) United States
(12) Patent Application Publication
(10) Pub. No.: US 2012/0087274 A1
(43) Pub. Date: Apr. 12, 2012

(54) METHOD AND APPARATUS OF COMMUNICATION OF PAYLOAD DATA

(75) Inventor: Laurence MERIAU, Plaisir (FR)

(73) Assignee: HUAWEI TECHNOLOGIES CO., LTD., Shenzhen (CN)

(21) Appl. No.: 13/282,225

(22) Filed: Oct. 26, 2011

Related U.S. Application Data
(63) Continuation of application No. PCT/IB2009/008053, filed on Oct. 30, 2009.

(51) Int. Cl. H04L 12/26

(52) U.S. Cl. 370/253

(57) ABSTRACT

The invention concerns transfer of payload data via a mobile communications network, wherein a communications terminal is configured to communicate payload data with a communication entity via the mobile communications network, the method comprising: sending, by the communications terminal, a request message, to set up a connection to the network, the request message including information to identify the terminal; including, by the communications terminal, the payload data to be communicated in the request message; and receiving, by the network, the request message in the network and routing at least part of the payload data to the communication entity.

### CROSS-REFERENCE TO RELATED APPLICATION

This application is a continuation of International Application No. PCT/IB2009/008053, filed on Oct. 30, 2009, which is hereby incorporated by reference in its entirety.

### TECHNICAL FIELD

The present invention relates to the technical field of transfer of payload data via a mobile communications network, and a communications apparatus adapted to communicate the payload data.

### BACKGROUND

It is conventionally known that mobile networks could be used for transmissions of payload data from different data generating devices to a receiver. Examples of such data generating devices are sensors, computers, machinery in manufacturing, components in automotive applications, etc.

Such transmission can for instance be effected by the use of the Short Message Service, which is a messaging service implemented originally in GSM (Global System for Mobile communication), but has since then been implemented in many different communication technologies.

Other transport mechanisms in mobile networks include packet oriented procedures, such as GPRS (General Packet Radio Service), and allow for more payload data transmission compared to the SMS.

In a Network, a device configured to transfer payload data via a mobile communications network would follow a certain procedure. For example, first, a terminal initiates a connection with the network to indicate its presence in the Network. Thereafter, the communication between the terminal and the network is started by using a suitable mechanism, such as SMS, to transfer shorter messages/information, and by using the GPRS bearer establishment procedures to establish tunnels when more data is about to be transferred.

As an example of this process, current mobile networks (such as 2G, 3G and LTE (Long Term Evolution) as described in 3GPP Standard TS 23.060, TS 23.401) allow data transfer for a User Equipment (UE) with several consecutives steps. With reference to FIG. 1, this process could be described in terms of 3GPP language as follows:
A UE accesses to the Network (Attach Request message, LAU (Local Area Update Request message) . . . ) to signal its presence to the Network;
UE signals its need for data transfer (this can be done at the step of the access to the Network for LTE-capable UEs);
Signalling in the Network takes place to establish the bearers (user plane tunnels) for each UE;
A UE context is created for each UE in each Network entity. For example, a Mobility Management Entity (MME)/Serving GPRS Support Node (SGSN) in a Mobility Management (MM) Control Plane (CP) entity; a Signalling Gateway (SGW)/PGW/Gateway GPRS Support Node (GGSN), which is to handle bearers of the UE, in Session Management entity; and Radio Access Network (RAN) in the Access entity, when the UE is active, to maintain the UE and the UE's bearers related information (such as UE context and UE's bearer contexts).
New local and temporary identifiers are allocated for the UE to allow future data transmission. The data includes P-TMSI (Temporary Mobile Subscriber Identity) and IP (Internet Protocol) address. The P-TMSI is the TMSI for services provided through the SGSN.

However, upon a further study of the conventional art, the inventor found the existing procedure for data transfer as discussed above contains a common technical problem that the data transfer is delayed when it comes close to the end of the Attach procedure, which happens individually for each of the user equipments.

### SUMMARY

It is an object of embodiments of the present invention to propose a solution for, or a reduction of the problems of the conventional art. A main object is consequently to provide a technical improvement over the conventional art.

According to an embodiment of the invention, this is accomplished with a method for transfer of payload data via a mobile communications network, wherein a communications terminal is adapted to communicate payload data with a communication entity via the mobile communications network, the method comprising:
sending a request message from the terminal to set up a connection to the network, the request message including information to identify the terminal,
including in the request message the payload data to be communicated,
receiving the request message in the network and routing at least part of the payload data to the communication entity.

According to a second aspect of the invention, the mentioned object is accomplished by a method for transfer of payload data via a mobile communications network, wherein a communications terminal is adapted to communicate payload data with a communication entity via the mobile communications network, the method comprising:
the terminal sending a request message to set up a connection to the network, the request message including information to identify the terminal, and
the terminal including in the request message the payload data to be communicated.

According to third aspect of the invention, the object is accomplished by a third method for transfer of payload data via a mobile communications network, wherein a communications terminal is adapted to communicate payload data with a communication entity via the mobile communications network, the method comprising:
the network receiving a request message from the terminal to set up a connection to the network, the request message including information to identify the terminal,
the network receiving the request message, wherein the request message also including the payload data to be communicated, and
the network routing the payload data to the communication entity.

According to a fourth aspect of the invention, the aforementioned object is accomplished by a communications terminal adapted to communicate in accordance with a method according to the second aspect of the invention.

According to fifth aspect of the invention, the object of the invention is accomplished by a mobile communications network adapted to communicate in accordance with a method according to a third aspect of the invention.

By including payload data already in a connection request message, the procedures mentioned in the background section above may be circumvented or relaxed and thereby resources in the Network for each such terminal be preserved.

Further advantageous aspects of the invention are disclosed in the remaining dependent claims.

### BRIEF DESCRIPTION OF THE DRAWINGS

Embodiments exemplifying the invention will now be described, by means of the appended drawings, on which

FIG. 1 is a flow chart illustrating communications according to the conventional art; and

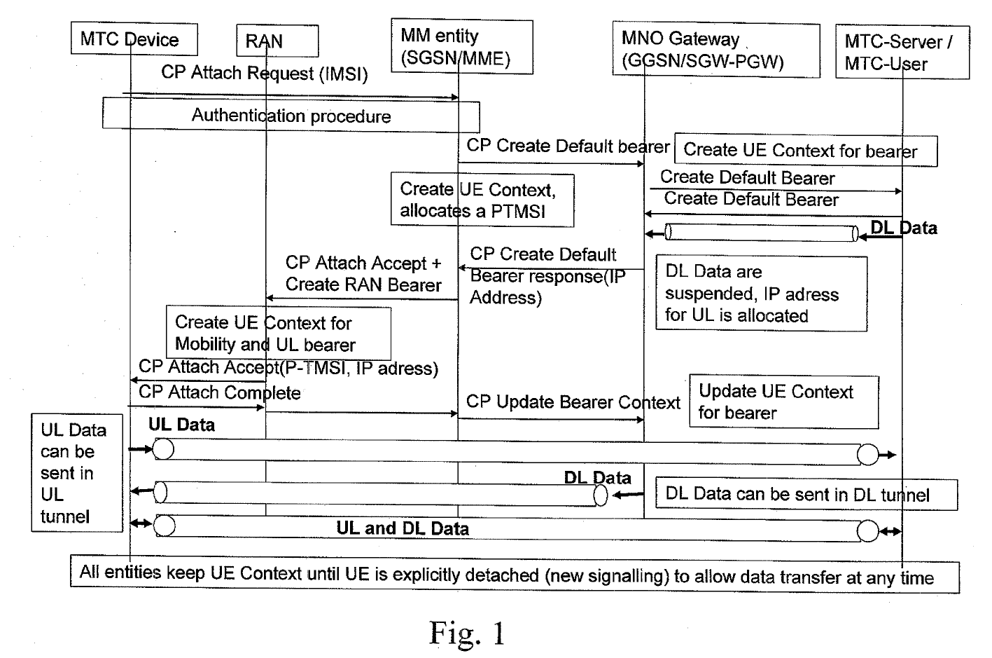

FIG. 2 is a flow chart illustrating communications of an example implementation according to an embodiment of the invention.

### DETAILED DESCRIPTION

Throughout this whole description, often different mobile communication systems are mentioned. It is to be understood that such mentioning of specific systems and terminology specific to such systems is provided as an exemplification of the inventive ideas in this document only. Thus, the present invention is applicable and can be applied in many different mobile communications systems. Further, throughout this whole description and also the claims, the term “terminal” or “communications terminal” are often used. It should be noted that these terms are intended to mean any device that is able to communicate with a mobile communications network. Such a device can for instance be a Machine to Machine (M2M) communications device etc. Thus, a communications terminal is able to use a mobile communications network but does not have to be mobile per se. The terminal or device could for example be a part of a permanent installation measuring an environment variable and reporting this variable via a mobile communications network to a receiver.

By including payload data already in a connection request message, the procedures mentioned in the background section above may be circumvented and thereby resources in the Network for each such terminal be preserved. This is of benefit when a communications terminal is expected to transfer a limited amount of data and e.g. only intermittently. That can be the case for a Machine Type Communication device. Since no context has to be preserved in the network, signalling inside the Network and resources can be saved. Further, since the payload data can be sent without prior negotiation, additional resources are saved and there is a potential for a swifter performance. Thus, the network can decide to allocate only resources necessary for the transfer of the data and, later, after such a transfer, may decide to release any resources after the procedure of data transfer has been completed and to detach the terminal.

It is identified that if an MTC (Machine Type Communication) Device and its MTC Server/MTC User transmit a small amount of data and perhaps only on rare occasions, e.g. there is long time-periods of no data transmission between data transfers, it would be advantageous to allow the MTC Device to use an attachment request to send data at the same time as the attachment request is sent. This is called “One Shot” data transfer in this description and avoids keeping MTC Device information in the Network (the MTC Device can be detached immediately after data has been transferred). This will save Network resources for potentially millions of MTC Devices.

The proposal is to allow connection less data transfer immediately during first access of the Device to the network (called an Attach procedure), and detach the Device immediately after if no more data is expected to be transferred:

Allow MTC Devices to perform an efficient data transfer via the Network at same time the UE attach to the Network (Up Link (UL) and Down Link (DL) data can be sent via Control Plane (CP) for example) to speed up data transfer and with minimal resource allocated in the Network.

After the data has been transferred, it is possible to free any MTC Device information in the Network.

To speed up data transfer, Data transfer can be done via Control Plane (CP) signalling, but also in a connection less way.

Current data transfer is well adapted to Human-to-Human communications for which it is expected that:
Duration of the communication is expected to be long or to take place often enough to have interest to reserve resources in the network (established bearer tunnels).
Humans expect to be always connected (resources are kept in the Network and are re-activated rapidly) so that communication terminal context information have to be kept in the Network.
Data amounts to be transferred are big enough to take benefit of tunnels established between the UE and its destination.
This mechanism is costly (signalling, network resources, data transfer later in the procedure).

However, this mechanism is not well adapted to machine to machine communications that may have different constraints. In particular, an important number of Machine-to-Machine Devices can be expected to have only low data transfer (there is only a few bits of data to be transferred), and sporadic transmissions with long period of silence (sensors like gas meters etc.), so that for example establishing tunnels is useless.

For such Machine-to-Machine services, using Human-to-Human procedures for Data transfer would bring a waste of signalling and resources in the Network and over the radio interface.

In addition, the signalling to support Human-to-Human procedures for data transfer is complex to implement in a Machine-to-Machine Device. Machine-to-Machine deployment will be facilitated if the amount of signalling needed to support in an MTC (Machine Type Communication) Device for its data transfer is minimized.

In addition, the signalling to support Human-to-Human data transfer is heavy to manage in the Network (contexts and signalling), and this will become even worse if it is used for millions of MTC Devices

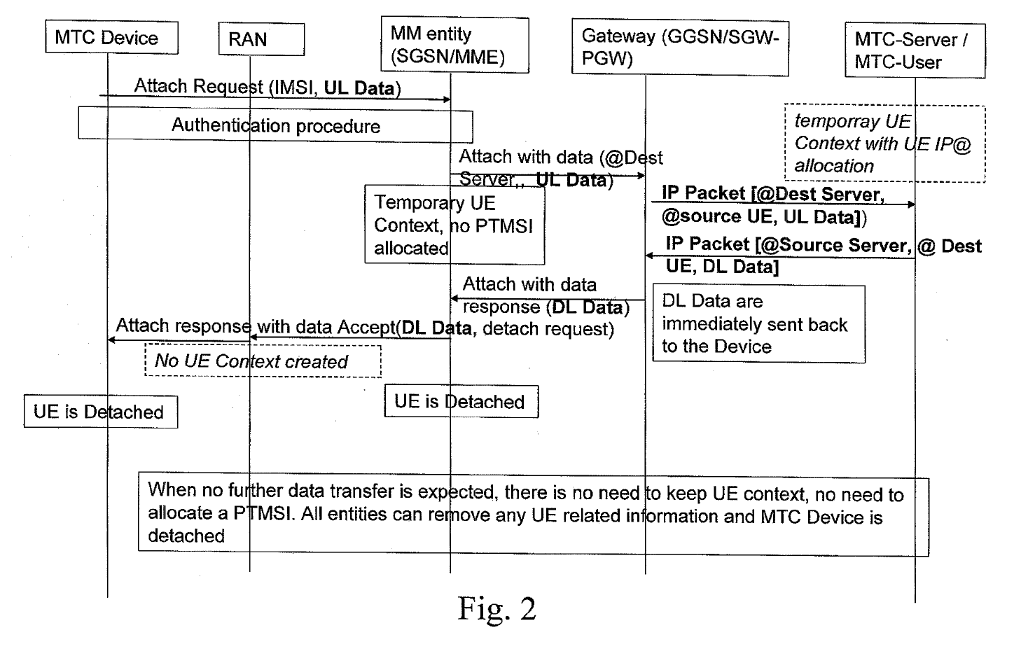

FIG. 2 illustrates communications of an example implementation for a 3GPP Network according to an embodiment of the invention.

Loading of a Mobile Network with signaling and/or preserving of device context may be avoided or reduced compared to the solutions in the conventional art while handling data transfers in an efficient way for a potential huge number of Machine-to-Machine Devices expected in a PLMN (Public Land Mobile Network).

The invention comprises a method for transfer of payload data via a mobile communications network. The method comprises some basic steps, each to conceptually be considered optional, and can be varied in accordance with many different sub steps to be discussed below. To each step of the method there is usually a physical correspondence somewhere in the network, such as a terminal that is programmed to execute a certain action of the method or a network constituent that has some kind of data processing entity that can interpret signalling from a terminal etc.

More specifically, the invention comprises a method for transfer of payload data via a mobile communications network, wherein a communications terminal is adapted to communicate payload data with a communication entity via the mobile communications network. The method comprises:
sending a request message from the terminal to set up a connection to the network, the request message including information to identify the terminal, and further
including in the request message the payload data to be communicated,
receiving the request message in the network and routing at least part of the payload data to the communication entity. Thus, the terminal does not have to be attached to the network, i.e. it does only setup a temporary connection with the network in order to transfer signals and associated payload data, in contrast to the prior art that first sets up a more permanent connection, before starting to send payload data. This saves resources, since the more permanent connection does not have to be set up, and is also potentially faster than the prior art.

The method according to the invention could further comprise in an additional step to send an acknowledge message to the communications terminal from the network. In this way, the terminal could get a confirmation that the message did go through to the communications entity.

A variant is to use the acknowledge message to also transfer payload information to the terminal. Thus, in connection with this step of sending an acknowledge message, the method of the invention could further yet comprise to include in the acknowledgment message also response payload data to the terminal from the communication entity.

A benefit of this “One-shot” data transfer is to avoid allocation of some terminal resources in the Network. It allows MTC (Machine Type Communication) Devices to perform an efficient data transfer via the Network: At the same time the MTC-device attach to the Network, Up Link (UL) and Down Link (DL) data can be sent, via for example Control Plane (CP) signalling, to speed up data transfer and with minimal resources allocated in the Network.

After the data has been transferred, there is a possibility to free any MTC Device information in the Network (One shot data transfer) for MTC Devices not expecting more data to be sent/received. Thus, the method according to the invention would then further comprise, in connection with sending the acknowledge message, to act on information in the network relating to the terminal by discarding in the network all information relating to the terminal. Such information in the network relating to the terminal could for instance be subscription information stored in the network from which can be derived that for a particular case, the terminal only transmits intermittently and therefore information relating to the terminal can be discarded.

Thus, information in the Network for such a Device can be removed just after data sending. After a One-Shot data sending, the MTC Device is detached. This saves Network resources for potentially millions of MTC Devices.

In a possible implementation:

1. Allow MTC (Machine Type Communication) Device to send its Up Link (UL) data from the beginning of its access procedure to the Network:
Data can be sent in the network signalling Control Plane, for example in the Control Plane (CP) Attach Request message sent to the network: MTC Device uses CP signalling to both access the Network and transfer UL data. This is the approach described in FIG. 2.

2. Allow the MTC Server/User to push its Down Link (DL) data during the access of the Device (such as in the response of the attachment, for example in Control Plane (CP) Attach Response message). MTC Server/User sends DL data during the procedure initiated by the MTC Device to access to the Network so that DL data is also transferred immediately.

3. Allow to release any Device resources at the end of this attachment procedure and associated data transfer and to detach the Device if no subsequent data transfer is expected from the MTC Device and from MTC Server/User. The MTC Device is detached and it needs to re-attach each time it needs to transfer new data.

4. During Attach, the MTC Device can provide the expected Access Point Name (APN) or a default subscribed APN will be used by the Mobility Management (MM) entity (as for legacy bearer management procedures) to determine the destination MTC Server/MTC User.

Instead of deciding to discard the information in the network relating to the terminal, the network can decide for the opposite. This can be useful if it is anticipated that further pay-load data is to be sent to or from the terminal in the near future. The method would then be expanded with the following steps:
acting on information in the network relating to the terminal by keeping in the network said information relating to the terminal in order to enable further payload data transfer, and
assigning a temporary mobile identity to the terminal and including said temporary mobile identity in the acknowledgement message to the terminal.

For instance, a Mobility Management (MM) entity in the network can act on information in the network by checking whether One Shot is to be done or not, to know whether it can avoid creating a terminal context and tunnels for data transfer and can detach the UE just after data transfer. If a context is to be created, it preferably assigns the temporary mobile identity to the terminal and sends it to the terminal in the acknowledge message. This enables the terminal identify itself for further uplink data transfers. As an alternative or a complement, the method could further comprise to acting on information in the network relating to the terminal by keeping in the network said information relating to the terminal in order to enable further payload data transfer, and to assign an Internet Protocol address to the terminal. By assigning an Internet Protocol address to the terminal, its identity can be communicated to other communication entities and thereby allowing further downlink payload data transfer.

The above mentioned different cases of acting on information in the network relating to the terminal could be based on information provided in different ways. For instance information already stored in the network in regard of the terminal, such as subscription information, or information provided by the terminal in the request message, or by information provided by the communication entity could be used to determine if a terminal context should be kept or not after the initial transfer of payload data.

The different steps of the method proposed could for instance be implemented in the following way in a network; the terminology is that for a 3GPP mobile network, but the specific implementation is applicable for other types of mobile networks as well:

Mobility Management (MM) Entity can determine if it is a One Shot data transfer when it receives data at the same time as attachment.

MM Entity checks the MTC (Machine Type Communication) Device expectation to always send One Shot data, based on subscription information (<<One Shot>> is subscribed for that MTC Device).

MM Entity can also determine this based on information provided by the MTC Device and MTC User:
MTC Device and MTC User can indicate if it is a One Shot data sending during Attach procedure.
MTC Device and MTC User can indicate expected delay before next data sending during the Attach procedure and depending on the delay before next data sending and the time needed for a new One-Shot (a new Attach), the MM entity can decide to keep UE context or to immediately detach the UE after One Shot data sending.

Source and Destination addresses for the transfer of payload data can be handled as follows:

During initial access to the Network, the MTC (Machine Type Communication) Device may ignore two important facts for the data transfer:
Its own IP (Internet Protocol) address to be used for potential Down Link (DL) data
The IP address of the destination MTC Server/MTC User to which it sends data to
Both can be determined by the Network so that the MTC Device does not have to provide this information in the data.

This information is needed when data is sent to an external Network (over the PGW Gi interface for a UMTS Network) to reach the correct communication entity such as a MTC Server/MTC User and to allow the MTC Server/MTC User to potentially send DL data back to the MTC Device.

The communications terminal does not have to provide its source IP (Internet Protocol) address (Device address over Gi) and the destination MTC (Machine Type Communication) Sever/MTC User's IP (Internet Protocol) address, but the Network (PGW) can fill in both the source IP address (Device address) and the destination IP address (for the MTC Server/MTC User: with the address determined by the Mobility Management (MM) entity) in the IP packet to be sent over Gi:
Either the Device send its Up Link (UL) data in an IP packet without those info in the IP header/or fill in the IP header using fake IP addresses and the PGW overwrite these fields
Or the Device sends only data, not in an IP packet, and the PGW builds the IP packet by adding the header with source and destination IP addresses that it fills in.

Above it has been said that for the embodied method in accordance with the invention, the communications terminal sends a request message to set up a connection to the mobile communications network and the including in the request message the payload data to be communicated. Such a request message could for instance be a network signalling control plane message. I.e., data could be transferred via a Control Plane (CP):

For MTC (Machine Type Communication) Device with Low data transfer characteristic, Up Link (UL) data transfer can be done at same time as the Access to the Network via the use of the Control Plane message, i.e. the small amount of data is encapsulated in the Control Plane (CP) message used to access to the Network. Down Link (DL) data sending can also be done in the same way, via DL CP Response message.

This avoids allocating bearer resources and avoids the seen to know bearer related signalling in the device.

Allow a MTC (Machine Type Communication) Device to send its Up Link (UL) data within the NAS Attach Request message, Control Plane (CP) signalling transports the UL data to the Mobility Management (MM) entity (Mobility Management Entity (MME)/Serving GPRS Support Node (SGSN)) MME changes it into GTP-C for transfer to Signalling Gateway (SGW)/PGW.

There is no need for the MM entity to check data Quality of Service (QoS), characteristics of data sent in the Control Plane (CP) are limited by the CP possibilities. This applies for low data rate transfer. MM entity can check MTC Device supports this Low data transfer subscription.

This MM entity determines the SGW/PGW destination point (reaching the MTC Server/MTC User) via legacy procedure based on the Access Point Name (APN) either provided by the MTC Device or a default APN subscribed.

The MM entity forwards UL data to the SGW/PGW reaching MTC User also via the Control Plane (CP) (GTP-C).

For Down Link (DL) data, PGW encapsulates the IP packet received from MTC Server/MTC User on Gi into GTP-C and MM entity transfers it to the MTC Device via NAS Control Plane (CP) Signalling.

Resources are released as soon as the response is sent back to the MTC Device.

The following advantages are thus achieved:

Efficient data transfer as data is sent at the same time as the signalling to access to the Network. Reduction of signalling is even greater with GPRS/UMTS RAT as a primary PDP context procedure is separated from the Attach procedure.

Reduced complexity of the MTC (Machine Type Communication) Device (no bearer concept, no bearer procedure).

Re-use of normal procedure to determine destination Signalling Gateway (SGW)/PGW but no need for bearer establishment (no CN (GTP-U) Bearer and no RAB establishment procedure with Radio Access Network (RAN) node): rapidly send a small amount of data.

As has been mentioned above, in one embodiment of the invention, information relating to the communications terminal can be kept in the network even after the initial transfer of payload data. At the same time, a temporary mobile identity could be assigned to the terminal and/or an internet protocol address could be assigned. This has the implication that:

For MTC (Machine Type Communication) Devices expecting future data transfer, the Network allocates a minimum of information. Data sending of small amount of data can still be done via the Control Plane (CP) (to avoid creating bearer resources).

The Network could decide whether it detaches the MTC Device or keep its context based on information regarding delay between two data transfers: MTC Device subscription or information provided by the MTC Device or the MTC User.

The Mobility Management (MM) entity can decide (based on resources saved regarding number of MTC (Machine Type Communication) Devices to handle for example and time expected between two data transmissions, based on MTC Device need to send more Up Link (UL) data . . . ) to memorize the MTC Device related information (IMSI/TMSI, latest Radio Access Network (RAN)) and to keep the device information for a certain time instead of detaching it to avoid a complete new One Shot procedure.

In case of subsequent Up Link (UL) data expected, Mobility Management (MM) entity allocates and provides a temporary identifier (S-TMSI) to the MTC (Machine Type Communication) Device in Attach Accept to allow its future access and context retrieval, the UE is kept attached but is moved to Idle mode as it has no bearer.

Thus, according to an embodiment of the invention, the method in connection with the step of assigning a temporary mobile identity to the terminal may further comprise to send from the terminal, via the mobile communications network, a further message including further payload data to the communication entity. In this way, terminals that are sending payload data a bit more often can still make use of the inventive concept to avoid creating bearer channels when there is a lesser amount of data to be transferred.

Subsequent UL data can be sent via Control Plane (CP) signalling (LAU (Local Area Update message), Service request . . . ): MTC Device encapsulates its UL data in the NAS Service Request and sends it together with S-TMSI to Mobility Management Entity (MME) (it is supposed the RRC is complete).

Again, a Control Plane (CP) procedure avoids need for bearer establishment in Core Network and in Access Network.

Further according to an embodiment of the invention, the method, in connection with the step of assigning an Internet Protocol address to the terminal, may further comprise: -sending from the communication entity, via the mobile communications network, a further message including further payload data to the terminal. In this way, terminals that are to receive payload data in addition to that potentially transferred in the acknowledge message can still make use of the idea of the invention to avoid creating bearer channels when there is a lesser amount of data to be transferred.

In case of subsequent Down Link (DL) data expected from the MTC Server/MTC User (MTC Device is not a MO only), minimal Mobility Management (MM) context information can be kept in the Network (at least to know the UE location (for appropriate paging) and Device's IP (Internet Protocol) address allocated when the device attached), to allow future DL data transfer to the MTC Device:

The UE is kept attached but can move to Idle mode as there is no bearer.

Subsequent DL data can be sent via DL Control Plane (CP) signalling and thus avoid any need for any bearer establishment in Core Network and in Access Network.

When an address of the communication entity has to be determined, it may be determined in various ways. For instance, according to a mode of the invention determining an address of the communication entity, recipient of the payload data, can be effectuated by means of information kept by the network associated with the terminal. Other ways include determining an address of the communication entity, recipient of the payload data, by means of communication entity information included by the terminal in the request message or with the payload data or determining an address of the communication entity, recipient of the payload data, by means of communication entity information provided by the communication entity to the network.

In a variant of the embodiment described above, the request message is an attachment request message to the communication Network. By an attachment request message is meant a network signalling control message that is sent from a communications terminal wanting to establish a connection with the mobile communications network.

In another variant of described embodiments, the payload data contains a network signalling control plane message such as a request message or a Short Message Service-message. This is a way to use the invention to tunnel network signalling messages to a chosen entity employing the method according to the invention.

Further according to the method according to the invention, the communications terminal can be a Machine Type Communication (MTC) device, as has been noted before.

The invention also comprises a method for transfer of payload data via a mobile communications network, wherein a communications terminal is adapted to communicate payload data with a communication entity via the mobile communications network, the method comprising:
the terminal sending a request message to set up a connection to the network, the request message including information to identify the terminal, and
the terminal including in the request message the payload data to be communicated.
   This method corresponds to the communications terminal part of the more general method of the invention described above. This method can be extended with any step previously mentioned in regard of said more general method of the invention described above where such a step involves activity in the communication terminal.

The invention also comprises a method for transfer of payload data via a mobile communications network, wherein a communications terminal is adapted to communicate payload data with a communication entity via the mobile communications network, the method comprising:
the network receiving a request message from the terminal to set up a connection to the network, the request message including information to identify the terminal, and
the network receiving the request message, wherein the request message also including the payload data to be communicated,
the network routing the payload data to the communication entity.

This method corresponds to the network part of the more general method of the invention described above. This method can be extended with any step previously mentioned in regard of said more general method of the invention described above where such a step involves activity in the communication network.

In one embodiment of the invention, a communications terminal is adapted to communicate in accordance with a method, described above, that corresponds to the communication-terminal part of the more general method of the invention described before.

Principally, the communications terminal can be arranged to perform any step of the method according to the invention, described above, as desired for a particular application and from a communications terminal point of view. The notion that the communications terminal is adapted to communicate in accordance with the method, described above, that corresponds to the communications terminal part of the more general method of the invention described before implies that it is provided with the necessary structures to put the method to use. Such structures could involve an electronic memory, a microprocessor, a circuit for sending electric signals, etc.

In one embodiment of the invention, the invention encompasses a mobile communications network adapted to communicate in accordance with the method, described above, that corresponds to the mobile communications network part of the more general method of the invention described before.

Principally, the mobile communications network can be arranged to perform any step of a method described above as desired for a particular application and from a mobile communications network point of view. The notion that the mobile communications network is adapted to communicate in accordance with a method, described above, that corresponds to the mobile-communications-network part of the earlier more generally described method implies that it is provided with the necessary structures to put the method according to the invention in use. Such structures could involve an electronic memory, a microprocessor, a circuit for sending electric signals, etc.

It should be noted that all different steps of the general method of the invention may be combined, notwithstanding order of mentioning, where they are not contradictory. For instance, the step to discard in the network all information relating to the terminal in connection with sending an acknowledge message could be combined with the step of including in the acknowledge message also payload data to the communications terminal from the communication entity. However, a step to keep in the network information relating to a particular terminal combined with the step to discard in the network all information relating to the terminal would be an example of a contradictory combination.

Effects:

The presence of this invention can easily be detected. If this proposal is implemented in a Network, Machine-to-Machine devices with small amount of data to be transferred will be allowed to transfer (send and receive) data during first access procedure with the Network and will not stay attached immediately (no P-TMSI (Temporary

Mobile Subscriber Identity)/IP (Internet Protocol) address allocation). Else immediate data sending will be impossible before a completion of Attach procedure.

Impact:

Efficient data transfer due immediate data transfer.

Simplifications of the Device (keep it low cost) and the network procedures and signalling:

No need for the Network to allocate a temporary identifier (PTMSI) and an IP (Internet Protocol) address for such MTC (Machine Type Communication) Device;

UE only attaches/detaches, there is no other Mobility Management procedure to take care in the MTC Device and in the Network;

No need for other procedure for data transfer in the MTC Device (no Service Request, no Paging), this keeps MTC Device cheap;

No need for bearer tunnel establishment as only small amount of data is transferred, this can be done connectionless.

Network resources being saved for millions of devices that will have to transfer data only on rare occasions:

No need to memorize MTC Device information in the Network for a one-shot data sending if both the UE and MTC Server/User do not expect to retransmit before a long period;

MTC Device is detached after the One-Shot Up Link (UL)/Down Link (DL) data transfer. There is no more information for the MTC Device in the Mobility Management Entity (MME), GW or Radio Access Network (RAN) node.

As is obvious for a skilled person, a number of other implementations, modifications, variations and/or additions can be made to the above described exemplary embodiments. It is to be understood that the invention includes all such other implementations, modifications, variations and/or additions which fall within the scope of the claims.

1. Method for transfer of payload data via a mobile communications network, wherein a communications terminal is configured to communicate payload data with a communication entity via the mobile communications network, the method comprising:
sending, by the communications terminal, a request message, to set up a connection to the network, the request message including information to identify the terminal;
including, by the communications terminal, the payload data to be communicated in the request message; and
receiving, by the network, the request message in the network and routing at least part of the payload data to the communication entity.

2. Method according to claim 1, further comprising:
sending an acknowledge message to the communications terminal from the network.

3. Method according to claim 2, further comprising:
including response payload data to the terminal from the communication entity in the acknowledgment message.

4. Method according to claim 2, wherein the sending the acknowledge message further comprises:
acting on information in the network relating to the terminal by discarding all information relating to the terminal in the network.

5. Method according to claim 2, further comprising:
acting on information in the network relating to the terminal by keeping the information relating to the terminal in the network in order to enable further payload data transfer; and
assigning a temporary mobile identity to the terminal and including the temporary mobile identity in the acknowledgement message to the terminal.

6. Method according to claim 2, further comprising:
acting on information in the network relating to the terminal by keeping in the network said information relating to the terminal in order to enable further payload data transfer, and
assigning an Internet Protocol address to the terminal.

7. Method according to claim 4, wherein said acting on information in the network relating to the terminal is based on any of: information already stored in the network in regard of the terminal, information provided by the terminal in the request message, and information provided by the communication entity.

8. Method according to claim 5, further comprising:
sending from the terminal, via the mobile communications network, another message including another payload data to the communication entity.

9. Method according to claim 6, further comprising:
sending from the communication entity, via the mobile communications network, another message including another payload data to the terminal.

10. Method according to claim 1, further comprising:
determining an address of the communication entity, recipient of the payload data, according to information kept by the network associated with the terminal.

11. Method according to claim 1, further comprising:
determining an address of the communication entity, recipient of the payload data, accordingly communication entity information included by the terminal in the request message or with the payload data.

12. Method according to claim 1, further comprising:
determining an address of the communication entity, recipient of the payload data, according to communication entity information provided by the communication entity to the network.

13. Method according to claim 1, wherein the request message is an attachment request message to the communication Network.

14. Method according to claim 1, wherein the payload data contains a network signalling control plane message.

15. Method according to claim 14, wherein network signalling control plane message is any of: a request message and a Short Message Service-message.

16. Method according to claim 1, wherein the communications terminal is a Machine Type Communication (MTC) device.

17. Method for transfer of payload data via a mobile communications network, wherein a communications terminal is configured to communicate payload data with a communication entity via the mobile communications network, the method comprising:
sending, by the terminal, a request message to set up a connection to the network, the request message including information to identify the terminal,
including, by the terminal, the payload data to be communicated in the request message.

18. Method for transfer of payload data via a mobile communications network, wherein a communications terminal is adapted to communicate payload data with a communication entity via the mobile communications network, the method comprising:
receiving, by the network, a request message from the terminal to set up a connection to the network, the request message including information to identify the terminal,
receiving, by the network, the request message, wherein the request message also including the payload data to be communicated,
routing, by the network, the payload data to the communication entity.

19. A communications terminal configured to communicate payload data with a communication entity via the mobile communications network in accordance with a method comprising:
sending, by the terminal, a request message to set up a connection to the network, the request message including information to identify the terminal,
including, by the terminal, the payload data to be communicated in the request message.
